(19) United States
(12) Patent Application Publication
(10) Pub. No.: US 2005/0155264 A1
(43) Pub. Date: Jul. 21, 2005

(54) Sign for vehicle

(76) Inventor: Jeffrey O. Meredith, San Diego, CA (US)

Correspondence Address: GORDON & REES LLP, 101 WEST BROADWAY, SUITE 1600, SAN DIEGO, CA, 92101, US

(21) Appl. No.: 10/758,655

(22) Filed: Jan. 15, 2004

(51) Int. Cl. G09F 21/04

(52) U.S. Cl. 40/591

(57) ABSTRACT

A sign for attachment to a vehicle door has a peripheral edge shape which simulates at least part of a human arm including an upper arm portion, an elbow portion, a lower arm portion, and at least a partial hand portion. The upper arm portion has a straight upper edge forming part of the peripheral edge of the sign, for locating against the lower edge of the vehicle door window with the sign positioned below the window. Magnetic material, suction cups, or the like may be used to secure the sign to the vehicle door. When positioned and secured, the appearance of the sign mimics that of a person in the vehicle hanging their arm out over the edge of the window.

### BACKGROUND OF THE INVENTION

The present invention relates generally to signs for ornamental, informational, or advertising purposes, and is particularly concerned with signs adapted for securing to a vehicle.

Vehicle signs have been proposed in the past. Some of these are designed to hang from the vehicle door via hooks, as described, for example, in U.S. Pat. No. 1,371,678 of Gerken and U.S. Pat. No. 1,473,583 of Lohn, Jr. U.S. Pat. No. 4,628,624 of Gunn describes a vehicle door mounted sign holder which has curved ends for engaging the edges of the vehicle door. U.S. Design Pat. No. 308,544 of Mansfield et al. illustrates a magnetic bumper sticker. All of these vehicle signs are of conventional, generally rectangular shape.

### SUMMARY OF THE INVENTION

It is an object of the present invention to provide a new and improved vehicle sign for removable attachment to a vehicle door.

According to the present invention, a sign is provided which comprises a member having at least the peripheral shape of at least part of a human arm including an upper arm portion, an elbow, a lower arm portion, and at least part of a hand, the upper arm portion having a straight upper edge, and a securing mechanism for releasably securing the member at a predetermined location on a car door such that the straight upper edge of the upper arm portion of the member abuts the lower straight edge of the car door window, whereby the appearance of the sign mimics that of a person in the car hanging their arm out of the open window.

The member may be a flat or planar member having a peripheral edge which is shaped to correspond to the shape of part of a human arm, with imprinted indicia on its upper surface to represent skin, tattoos, sleeves, and the like. Alternatively, the member may be a solid or hollow three-dimensional member with a rounded outer surface representing an outer part of an arm if hanging out of a vehicle window, with a peripheral edge of partial arm-like shape. In the latter case, the member will have a generally flat or smooth arcuate inner face for attachment to a door by suitable fasteners such as magnets, tethers, suction cups or the like, and a rounded outer face.

In an exemplary embodiment, the sign is a flat, planar member which may be made of permanent magnet sheet material similar or equivalent to that used in manufacturing refrigerator door signs, such as die-cut magnetic rubber, or may have other securing means for securing to a car door, such as separate magnet pads secured to a rear face of the planar member, suction cups, and/or a tether device for securing the member to the arm of a side view mirror of the vehicle. The upper face of the planar member may have imprinted advertising and ornamental indicia. In an exemplary embodiment of the invention where the planar member itself is of magnetic sheet material, the member has a lower peripheral edge cut to represent a shadow around the lower edge of the arm, and the indicia include an arm having a lower edge, and a dark or black strip region extending around the lower edge of the arm indicia to represent the shadow. This will provide a 3-D effect when the arm member is secured to the car door.

The indicia representing the arm, as well as the cut out peripheral edge, may be arranged to represent an arm with a short sleeve, a long sleeve, no sleeve, and/or a wrist band. Other indicia, such as advertising logos and the like, may be printed on the sleeve or directly on the arm to provide the impression of a tattoo.

The planar member is cut at one end to form the shape of at least part of a hand. In one embodiment, a complete hand in the form of a fist is formed. Alternatively, a hand gripping another item such as a ball may be represented. In yet another embodiment, the peripheral shape of the sign is that of a bent arm, and the hand is cut off to provide a second, upper straight edge aligned with the first straight edge at the upper end of the upper arm portion. The second straight edge will also be aligned with the lower edge of the vehicle door window when the sign is secured to the car door, to further enhance the appearance of a real arm hanging out of the window with the hand gripping the edge of the window opening.

The vehicle sign of this invention is therefore arranged to mimic the appearance of a car driver or passenger hanging their arm out of an open vehicle window, and provides a 3-D effect to better reproduce the appearance of a real arm. This will provide a novel visual impression to the occupants of other vehicles as well as pedestrians.

### BRIEF DESCRIPTION OF THE DRAWINGS

The present invention will be better understood from the following detailed description of some exemplary embodiments of the invention, taken in conjunction with the accompanying drawings in which like reference numerals refer to like parts and in which:

FIG. 1 is a front elevation view of a vehicle sign according to a first embodiment of the invention, the rear view being plain and unornamented;

FIG. 2 is a top plan view of the sign of FIG. 1;

FIG. 3 is a bottom plan view of the sign of FIG. 1;

FIG. 4 is a front elevation view of the sign of FIG. 1 mounted on a vehicle door;

FIG. 5 is a front elevation view similar to FIG. 4 illustrating a modified vehicle sign in use on a vehicle door;

FIG. 6 is a front elevation view similar to FIGS. 4 and 5 illustrating another modified vehicle sign;

FIG. 7 is a front elevation view similar to FIGS. 4 to 6 illustrating another modified vehicle sign;

FIG. 8 is a front elevation view similar to FIGS. 4 to 7 illustrating another modified vehicle sign;

FIG. 9 is a front elevation view similar to FIGS. 4 to 8 illustrating another modified vehicle sign;

FIG. 10 is a front elevation view of a vehicle sign according to another embodiment of the invention, using non-magnetic means to attach to the vehicle door; and

FIG. 11 is a front elevation view of another modified vehicle sign mounted on a vehicle door, with alternative or additional means of attachment to the door.

### DETAILED DESCRIPTION OF THE DRAWINGS

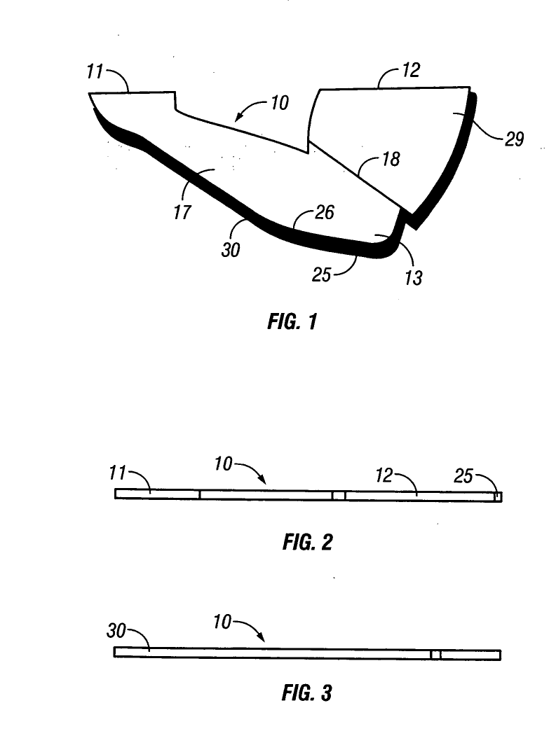

FIGS. 1 to 4 illustrate a vehicle sign 10 according to a first embodiment of the present invention. The sign 10 comprises a flat panel of sheet material such as metal, plastic or the like, which is die-cut with a predetermined peripheral edge shape representing the shape of a bent arm. The panel may be made of die cut magnetic rubber, or may be die-cut non-magnetic sheet material with magnet pads or strips (not illustrated), or other adhering means, secured to its rear face.

The arm-shaped sign includes a partial hand portion with an upper straight edge 11, an upper arm portion with an upper straight edge 12 aligned with edge 11, an elbow portion 13, and a lower arm portion 17. The upper part of the periphery of the sign therefore has a first straight portion 11, a second straight portion 12 spaced from the second straight portion, and a generally indented or asymmetrical V-shape between the two straight portions to represent the upper edge of an arm in side view. The lower part of the periphery of the sign follows the same general shape as a bent arm in side view, including a shadow cast by the arm, as explained in more detail below.

The upper face of the sign is imprinted with indicia to produce the impression of an arm of an individual wearing a short sleeved shirt, with line 18 representing the lower edge of the shirt sleeve 29, and a shadow 25 extending around the lower edge 26 of the arm. The cut-out peripheral shape of the sign therefore has a lower edge 30 cut to form the shape of the lower edge of a shadow 25 which would be formed by a real arm with a short shirt sleeve covering an upper portion of the arm, and the indicia include a darkened or black strip to form the shadow 25 around the lower edge 26 of the arm, which is formed in a lighter, arm-like color, and sleeve, with an indent at the lower edge of the sleeve. If desired, indicia such as sport team logos, ornamental shapes, or other advertising or ornamental indicia, may be imprinted on the sleeve region of the arm shape.

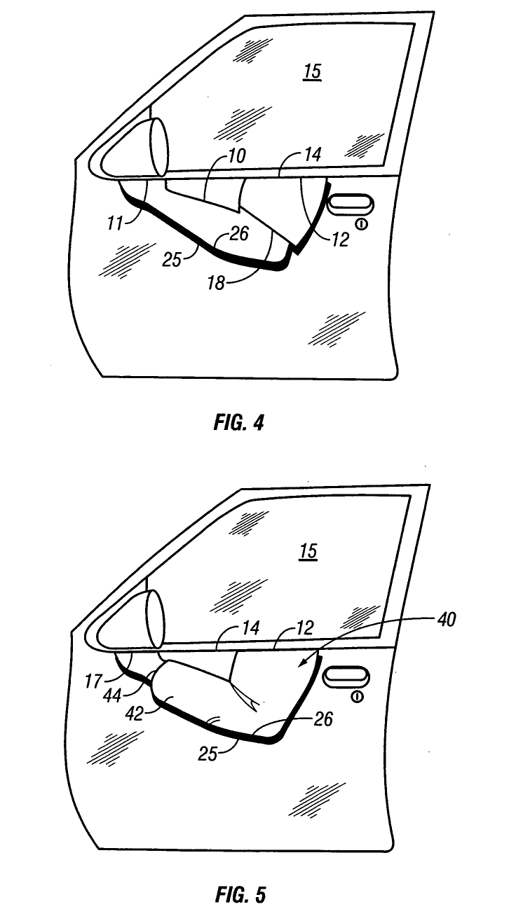

FIG. 4 illustrates the positioning of the arm-shaped sign 10 on a left hand or driver side door of a vehicle. It will be understood that the arm-shaped sign 10 of FIGS. 1 to 4 represents a left arm and is designed to be mounted on the left hand door. However, arm-shaped signs may be manufactured in a similar manner to represent a right arm (i.e. the mirror image of the sign as illustrated in FIG. 1) and may be attached in the same way to the right hand or passenger side door of a vehicle. As illustrated in FIG. 4, the sign is placed on the vehicle door below the lower edge 14 of the window 15, such that the straight edges 11, 12 at the upper ends of the partial hand and upper arm regions are positioned against the edge 14. The remainder of the sign therefore has the appearance of a bent arm hanging down from the car window. The dark rim or edge region 25 around the lower edge 26 of the “arm” has the appearance of a shadow, providing a 3-D effect which mimics the appearance of a real arm, at least to a casual observer.

The arm-shaped sign 10 as illustrated in FIGS. 1 to 4 has no other ornamentation or indicia on its upper surface other than the representation of a lower edge 26 of the arm, a darkened or black shadow region 25 extending around the lower edge of the arm, and the lower edge 18 of the sleeve. However, the sleeve region 29 may have imprinted indicia of any desired form, such as numbers, words, shapes, logos, and the like, for advertising, ornamental, or informational purposes. The sleeve region may, for example, carry indicia of a sports team. In the latter case, the sign may be an item offered for sale at sporting events featuring the represented team.

FIG. 5 illustrates an arm shaped sign 40 according to another embodiment of the invention in which the representation 29 of a short sleeve on the arm is replaced with indicia representing a long sleeve 42, with a lower edge or cuff 44 adjacent the hand portion of the sign. Other parts of the sign are identical to the previous embodiment, and like reference numerals are used for like parts as appropriate. The shadow region 25 of the indicia and the corresponding lower peripheral edge 30 of the sign are suitably modified to allow for the cuff 44 of the long sleeve region 42 of the indicia, as indicated in FIG. 5.

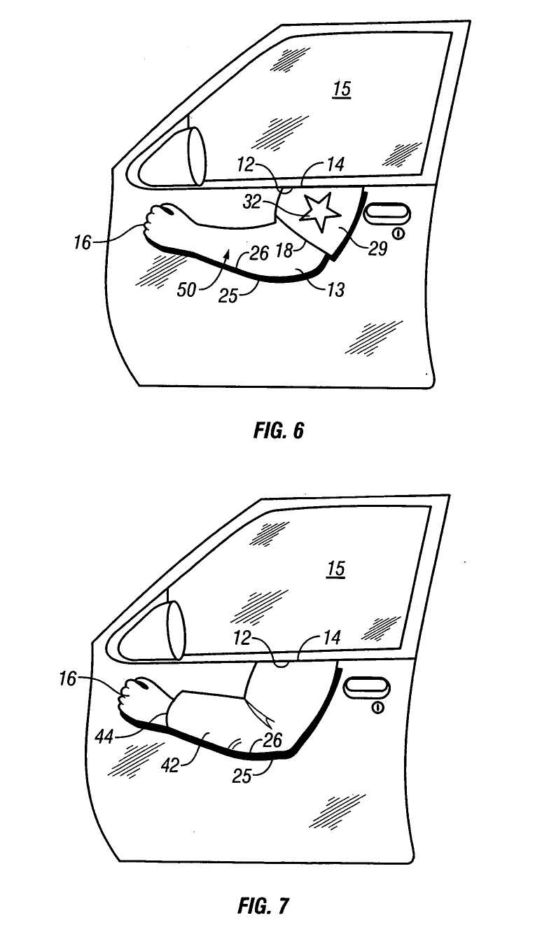

FIG. 6 illustrates another modified arm shaped sign 50 in which the partial hand portion with an upper straight edge 11 is replaced with a complete hand region in the form of a fist 16, which will be spaced below the lower edge 14 of the window when the sign is attached to the door. In this case, the shadow region 25 is slightly modified to allow for the shadow of the fist-shaped hand region 16. The sign is cut out with the elbow 13 bent at a slightly greater angle than in FIGS. 4 and 5, so that the lower arm region extends out in a generally horizontal direction across the car door, rather than bending up to the window. Other parts of the sign are the same as in the first embodiment, including a short shirt sleeve region 29 with a lower edge 18, and like reference numerals are used for like parts as appropriate. In this embodiment, indicia representing a star shape 32 are also provided on the short sleeve region 29. It will be understood that many other shapes, words, numbers, logos or the like may be used in place of the star 32 in alternative signs, as explained above in connection with FIG. 1.

Although the hand region is in the form of a fist 16 in the sign 50, the hand may be represented with the fingers extended by suitable cutting of the outer periphery of the sign and suitable finger and thumb indicia added to the upper surface. It may alternatively be in the form of a hand gripping another item, such as a hand gripping a football or other article.

FIG. 7 illustrates a modification of the sign 50 of FIG. 6, in which the short sleeve is replaced with a long sleeve region 42 with a lower edge or cuff 44, as in FIG. 5, with corresponding modification of shadow region 25 to exclude the indent representing the shadow of the edge 18 of the short sleeve in FIG. 6. Other parts are identical to those of previous embodiments, and like reference numerals are used for like parts as appropriate.

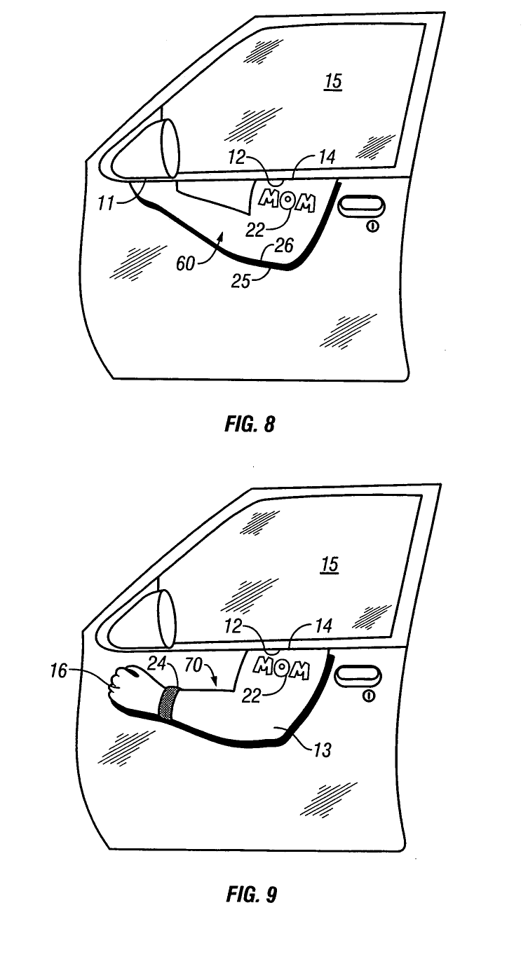

FIG. 8 illustrates another modified arm-shaped sign 60 in which the indicia on the upper face are designed to represent a bare arm, with no sleeve. Other parts of the sign are identical to that of the first embodiment, and like reference numerals are used for like parts as appropriate. In this embodiment, a partial hand region with an upper straight edge 11 is represented, although this may be replaced with the fist shape 16 as in FIGS. 6 and 7 if desired. The shadow region 25 along the lower edge of the sign is modified to represent a shadow as would be cast by a bare arm, and therefore excludes the indents in region 25 in FIGS. 1 to 6 which represented the edges of the short or long sleeve. The indicia may include the representation of a tattoo 22 on the bare arm, with the tattoo taking any desired form. The tattoo may, for example, be designed to promote sporting events such as wrestling, or may represent a cartoon character or the like.

FIG. 9 illustrates a modified bare arm-shaped sign 70 in which a wrist-band representation 24 is added to the indicia, and the partial hand region with a cut-off straight edge 11 is replaced with a fist region 16 as in the embodiments of FIGS. 6 and 7. A wrist-band representation may also be added to any of the short sleeved signs of the previous embodiments. The sign 70 otherwise has elements identical to those of one or more previous embodiments, and like reference numerals have been used for like elements as appropriate.

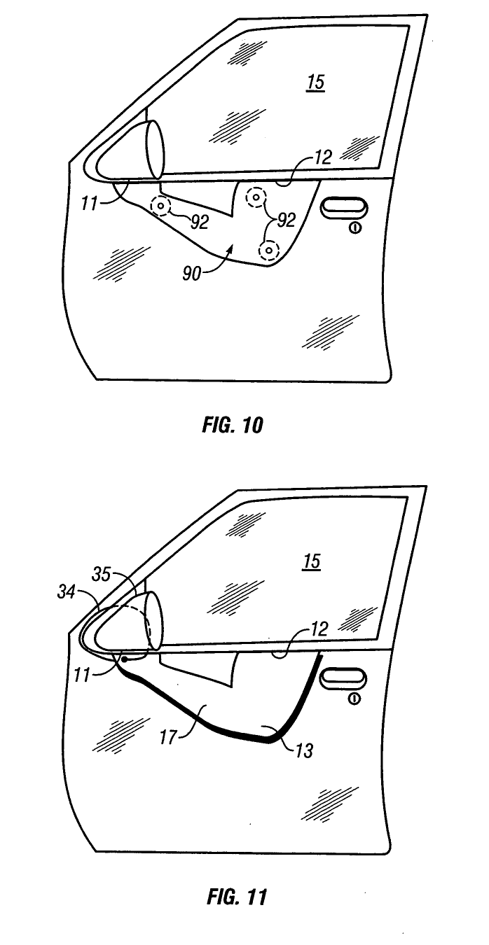

FIG. 10 illustrates a hand-shaped sign 90 according to another embodiment of the invention. In this embodiment, instead of using magnetic means (either magnetic sheet material forming the sign or magnets adhered to the rear face of the sign) to adhere the sign to a vehicle door, the rear face of the sign has a series of suction cups 92, as indicated in dotted outline. The suction cups 92 are used to releasably attach the sign to the door. In this case, the sign 90 will be a flat panel of suitable rigid material such as metal or plastic, with imprinted indicia on its front face. Due to the suction cups 92, the panel is raised from the surface of the car door, and thus will cast its own shadow when in use. There is therefore no need for an extended shadow region 25 to be provided, as was present in the previous embodiments. In this case, therefore, the sign 90 is cut out to form the periphery of an arm alone, with no peripheral shadow region.

In FIG. 10, the sign 90 is shown as a bare arm, with no other indicia, and with a cut-off upper arm and hand region along straight lines 11 and 12 for mating with the lower edge 14 of the window 15. However, it will be understood that it may alternatively be formed with any of the peripheral arm shapes of FIGS. 1 to 9, such as short sleeve, long sleeve, tattoo, and/or armband, as well as with any desired indicia on the arm itself or on any sleeve region represented on the sign. It may also be provided in a fist version as in FIGS. 6 to 9. The sign 90 of FIG. 10 is particularly designed for use on vehicles which are made of materials other than metal, but can be used on any vehicle.

FIG. 11 illustrates a possible modification to any of the previous embodiments. In this alternative, additional fastener means are provided for preventing possible loss of the sign. In this case, a hole 33 is provided in the hand portion of the sign, and a tether 34 extends through the hole 33 and around the mounting rod (not visible in the drawings) of the side view mirror 35. This ensures that the sign will remain attached to the vehicle even in high wind conditions or the like when the suction cups or magnetic adhesion may be insufficient to retain the sign on the vehicle door.

It will be understood that the vehicle sign of this invention may be made in different arm shapes and upper arm/lower arm orientations, as well as with other clothing represented by the indicia, such as no sleeves, short sleeves, long sleeves, arm bands, watches, gloves, and the like. The indicia may be designed to represent a simulated motor racing suit sleeve and glove. In each case, the hand portion of the sign may be cut off as in FIGS. 1 to 5,8, and 10, or may be in the form of a complete fist, as in FIGS. 6,7 and 9, or may be in some other shape, or holding an object such as a ball, soda can, or the like. Instead of a flat panel, the sign may be of a three-dimensional shape representing an outer part of an arm. In this case, it will be of a suitable lightweight material, and will have a curved outer surface of varying dimensions to represent an actual arm contour. It will also have imprinted indicia as in the previous embodiment, representing bare arms, short sleeves, tattoos, arm bands and the like, as desired.

Any suitable means may be used to releasably secure the sign to the door, such as magnetic adhesion, suction cups, releasable adhesive, and the like, with or without a tether as in FIG. 11. In any case where the sign is a flat panel secured flat against the door, as when it is formed from die cut magnetic rubber, the arm shape will be cut out with an integral shadow portion along the lower edge which is printed in black or a dark color. The integral shadow portion along the lower edge is omitted in cases where the sign is held spaced above the door surface, since it will automatically cast its own shadow in sunlight or bright conditions.

In each of these embodiments, an attractive sign is provided for a car or other vehicle door which will simulate an arm hanging out of the window of the door, either with the hand gripping the lower edge of the window or simply placed on the outer surface of the door. The provision of an integral shadow portion on the flat panel versions of the sign will create a 3-D illusion, so that the appearance is that of a real arm to the casual observer when the vehicle passes them. Any desired indicia may be provided on the arm for informational, advertising, or ornamentation purposes.

Although some exemplary embodiments of the invention have been described above by way of example only, it will be understood by those skilled in the field that modifications may be made to the disclosed embodiments without departing from the scope of the invention, which is defined by the appended claims.

1. (canceled)

2. The sign as claimed in claim 12, wherein the member is a flat, planar member.

3. The sign as claimed in claim 2, wherein the planar member is made of magnetic sheet material, the magnetic material comprising the securing mechanism for magnetically adhering the sign to a vehicle door.

4. The sign as claimed in claim 3, wherein the planar member is made of die-cut magnetic rubber material.

5. The sign as claimed in claim 2, wherein the planar member has an upper face and a lower face, and the securing mechanism comprises at least one magnet secured to the lower face of the planar member.

6. The sign as claimed in claim 7, wherein the member has a lower face, and the securing mechanism comprises a plurality of suction cups secured to the lower face of the member.

7. A sign for a vehicle door, the sign comprising:
a member having a predetermined periphery with a shape which simulates at least part of a human arm including an upper arm portion, an elbow portion, a lower arm portion, and a hand portion simulating at least part of a hand;
the upper arm portion having a straight upper edge forming part of the periphery of the member;
a securing mechanism for releasably securing the member at a predetermined location on a vehicle door such that the straight upper edge of the upper arm
portion of the member abuts the lower straight edge of a window of the vehicle door, whereby the appearance of the sign mimics that of a person in the vehicle hanging their arm out of the open window; and
a tether device for securing the hand region of the member to a vehicle side view mirror mounting rod.

8. The sign as claimed in claim 7, wherein the member is a flat, planar member having an upper face, an upper edge, and a lower edge, the upper face having imprinted indicia.

9. A sign for a vehicle door, the sign comprising:
a member having a predetermined periphery with a shape which simulates at least part of a human arm including an upper arm portion, an elbow portion, a lower arm portion, and a hand portion simulating at least part of a hand;
the upper arm portion having a straight upper edge forming part of the periphery of the member;
a securing mechanism for releasably securing the member at a predetermined location on a vehicle door such that the straight upper edge of the upper arm portion of the member abuts the lower straight edge of a window of the vehicle door, whereby the appearance of the sign mimics that of a person in the vehicle hanging their arm out of the open window;
the member comprising a flat, planar member;
the planar member having an upper face, an upper edge, and a lower edge, the upper face having imprinted indicia; and
the imprinted indicia comprising a lower edge of a bent arm spaced from the lower edge of the planar member, and a shadow region darker than the remainder of the upper face extending from the lower edge of the bent arm indicia to the lower edge of the planar member, whereby the shadow region simulates a shadow which would be cast by a real arm to provide a 3-D effect when the arm member is secured to a vehicle door.

10. The sign as claimed in claim 8, wherein the indicia include a lower edge of a sleeve.

11. The sign as claimed in claim 8, wherein the indicia include a wrist band.

12. A sign for a vehicle door, the sign comprising:
a member having a predetermined periphery with a shape which simulates at least part of a human arm including an upper arm portion, an elbow portion, a lower arm portion, and a hand portion simulating at least part of a hand;
the upper arm portion having a straight upper edge forming part of the periphery of the member; and
a securing mechanism for releasably securing the member at a predetermined location on a vehicle door such that the straight upper edge of the upper arm portion of the member abuts the lower straight edge of a window of the vehicle door, whereby the appearance of the sign mimics that of a person in the vehicle hanging their arm out of the open window
the hand portion of the member having an upper straight edge forming part of the peripheral edge of the member, the upper straight edge being aligned with the upper straight edge of the upper arm portion, whereby the sign can be secured to a vehicle door with both straight edges abutting the lower edge of the window of the door.

13. The sign as claimed in claim 12, wherein the shape of the periphery of the member simulates a bent arm with a bent elbow region between the upper and lower arm portions.

14. The sign as claimed in claim 9, wherein the shape of the periphery of the member at the hand portion represents a complete hand.

15. The sign as claimed in claim 12, wherein the shape of the periphery of the member includes at least one indent representing the edge of a sleeve on the arm.

16. The sign as claimed in claim 12, wherein the member has a three dimensional, partial arm shape.

17. (canceled)

18. (canceled)

19. The sign as claimed in claim 8, wherein the planar member is made of die cut magnetic sheet material.

20. The sign as claimed in claim 9, wherein the planar member is of flat sheet material having an upper face and a lower face, the sign further comprising securing means on the lower face of the planar member for releasably securing the planar member to a vehicle door below a window.

21. The sign as claimed in claim 20, wherein the securing means comprises at least one magnet.

22. The sign as claimed in claim 20, wherein the securing means comprises a plurality of suction cups.
